(19) United States
(12) Patent Application Publication
(10) Pub. No.: US 2023/0220946 A1
(43) Pub. Date: Jul. 13, 2023

(54) THERMAL INSULATION PANEL AND METHOD FOR MANUFACTURING SAME

(71) Applicant: SANKEI GIKEN KOGYO CO., LTD., Tokyo (JP)

(72) Inventors: Shinya Motooka, Tokyo (JP); Keisuke Nakamura, Isesaki-shi (JP); Kenichi Arai, Tokyo (JP); Makoto Makinoda, Tokyo (JP)

(73) Assignee: SANKEI GIKEN KOGYO CO., LTD., Tokyo (JP)

(21) Appl. No.: 18/021,311

(22) PCT Filed: Jun. 24, 2021
(86) PCT No.: PCT/JP2021/024046

§ 371 Date: Feb. 14, 2023

(30) Foreign Application Priority Data
Aug. 31, 2020 (JP) 2020-145980

(51) Int. Cl. F16L 59/065

(52) U.S. Cl. CPC F16L 59/065

(57) ABSTRACT

A thermal insulation panel is characterized in that first flange parts are formed at an edge part on one side of an axis direction of a flattened metal cylinder and the first flange parts are overlaid on and welded to each other in such a manner as to close the one edge part, second flange parts are formed at an edge part on the other side of the axis direction of the flattened metal cylinder and the second flange parts are overlaid on and welded to each other in such a manner as to close the other edge part, and thermal insulation space is provided inside the flattened metal cylinder. A welding length is shortened significantly and welding operation is reduced during manufacture of the thermal insulation panel to achieve improvement of manufacturing efficiency and achieve reduction in manufacturing cost.

### TECHNICAL FIELD

The present invention relates to a thermal insulation panel with thermal insulation space provided inside a double wall, and a method for manufacturing the same.

### BACKGROUND ART

Vacuum thermal insulation panels disclosed in Patent Literatures 1 and 2 have conventionally been known as thermal insulation panels each including thermal insulation space provided inside a double wall. Such a vacuum thermal insulation panel is formed by providing a bulge at each of the center of a first metal plate and the center of a second metal plate, placing respective internal recesses of the bulges at positions facing each other to include thermal insulation space and stacking the first metal plate and the second metal plate on each other in such a manner as to house a thermal insulation material in the thermal insulation space, interposing the first metal plate and the second metal plate between an upper electrode and a lower electrode with a flange part provided along an entire periphery covering the four sides of the first metal plate and a flange part provided along an entire periphery covering the four sides of the first metal plate overlaid on each other, and joining the overlaid flange parts (edge parts) to each other by seam welding (see paragraphs [0020] and [0051] to [0054] and FIGS. 1, 2, and 5 of Patent Literature 1, and paragraphs [0021] and [0052] to [0055] and FIGS. 1, 2, and 5 of Patent Literature 2).

### CITATION LIST

### Patent Literature

Patent Literature 1: Japanese Patent Publication No. 6223507
Patent Literature 2: Japanese Patent Publication No. 6223611

### SUMMARY OF INVENTION

### Problem to be Solved by Invention

Meanwhile, the vacuum thermal insulation panels of Patent Literatures 1 and 2 each require implementation of the seam welding along the entire periphery covering the four sides of the panel, resulting in increased welding length of welding of the overlaid flange parts to each other and extended operating time required for the welding. In response to this, in manufacturing a thermal insulation panel, manufacturing efficiency is required to be improved by shortening a welding length and reducing welding operation. Furthermore, while a large current is required in the seam welding for welding the overlaid flange parts to each other, a longer welding length results in increased amount of required current, causing a different problem of increased manufacturing cost.

The present invention is suggested in view of the foregoing problems, and is intended to provide a thermal insulation panel and a method for manufacturing the same that achieve improvement of manufacturing efficiency and achieve reduction in manufacturing cost by shortening a welding length significantly and reducing welding operation during manufacture of the thermal insulation panel.

### Means of Solving Problem

A thermal insulation panel of the present invention is characterized in that first flange parts are formed at an edge part on one side of an axis direction of a flattened metal cylinder and the first flange parts are overlaid on and welded to each other in such a manner as to close the one edge part, second flange parts are formed at an edge part on the other side of the axis direction of the flattened metal cylinder and the second flange parts are overlaid on and welded to each other in such a manner as to close the other edge part, and thermal insulation space is provided inside the flattened metal cylinder.

In this configuration, during manufacture of the thermal insulation panel, it is sufficient to perform welding only at the flange parts along two sides corresponding to the one edge part and the other edge part of the flattened metal cylinder and welding is not required to be performed along the other two sides facing each other. This makes it possible to shorten a welding length significantly compared to the case where welding is performed along an entire periphery covering the four sides of a panel. This considerably reduces welding operation during manufacture of the thermal insulation panel to achieve improvement of manufacturing efficiency. Moreover, as a welding length can be shortened significantly during manufacture of the thermal insulation panel, welding cost is reduced considerably to achieve reduction in manufacturing cost.

The thermal insulation panel of the present invention is characterized in that the thermal insulation space is reduced-pressure space and a thermal insulation support is fitted into the reduced-pressure space.

In this configuration, if the thermal insulation panel is a vacuum thermal insulation panel including reduced-pressure space inside the panel, leakage from the welded part formed during manufacture of the thermal insulation panel becomes a serious factor for time degradation of the vacuum thermal insulation panel. In this regard, the welded parts are formed limitedly along the two sides compared to the entire periphery of the panel to reduce the welded part during manufacture of the thermal insulation panel. By doing so, it becomes possible to considerably reduce a likelihood of the occurrence of leakage due to time degradation. Furthermore, fitting the thermal insulation support into the reduced-pressure space makes it possible to retain the reduced-pressure space stably for a long time and maintain high thermal insulation performance.

The thermal insulation panel of the present invention is characterized in that the reduced-pressure space is provided adjacent to two sides facing each other and differing from two sides facing each other where the one edge part is welded and the other edge part is welded respectively, and the thermal insulation support is fitted into an area of the reduced-pressure space adjacent to the two sides.

In this configuration, by providing the reduced-pressure space adjacent to the two sides facing each other and differing from the welded two sides facing each other, it becomes possible to extend a panel region to contribute to thermal insulation property more widely while minimizing a panel region corresponding to a wide flange part for welding and not to contribute to thermal insulation property in an extension direction of a panel surface. As a result, the thermal insulation property of the vacuum thermal insulation panel can be improved further. Furthermore, the dimension of the reduced-pressure space adjacent to the two sides facing each other and differing from the welded two sides facing each other is retained by the thermal insulation support to allow the state of the reduced-pressure space to be maintained stably for a long time in the above-described adjacent area, making it possible to maintain high thermal insulation performance.

The thermal insulation panel of the present invention is characterized in that the thermal insulation space is provided adjacent to two sides facing each other and differing from two sides facing each other where the one edge part is welded and the other edge part is welded respectively.

In this configuration, by providing the thermal insulation space adjacent to the two sides facing each other and differing from the welded two sides facing each other, it becomes possible to extend a panel region to contribute to thermal insulation property more widely while minimizing a panel region corresponding to a wide flange part for welding and not to contribute to thermal insulation property in an extension direction of a panel surface. As a result, the thermal insulation property of the thermal insulation panel can be improved further.

The thermal insulation panel of the present invention is characterized in that the flattened metal cylinder is formed by flattening under pressure.

In this configuration, using elastic restoring force generated during the flattening under pressure, a thickness in the thermal insulation space inside the panel can be maintained stably for a long time. This contributes to extension of product lifetime.

A method for manufacturing a thermal insulation panel of the present invention is a method for manufacturing the thermal insulation panel of the present invention comprising: a step of forming the flattened metal cylinder by deforming a metal cylinder under pressure in such a manner as to squeeze the metal cylinder.

In this configuration, by forming the flattened metal cylinder by deforming the metal cylinder under pressure in such a manner as to squeeze the metal cylinder, a thickness in the thermal insulation space inside the panel can be maintained stably for a long time using elastic restoring force generated in deformation under pressure during squeezing. This contributes to extension of product lifetime.

A method for manufacturing a thermal insulation panel of the present invention comprises: a first step of forming a flattened metal cylinder by deforming a metal cylinder under pressure in such a manner as to squeeze the metal cylinder; a second step of forming first flange parts at an edge part on one side of an axis direction of the flattened metal cylinder, and overlaying the first flange parts on each other and welding the first flange parts to each other in such a manner as to close the one edge part; a third step of fitting a thermal insulation support into the flattened metal cylinder; and a fourth step of forming second flange parts at an edge part on the other side of the axis direction of the flattened metal cylinder, and overlaying the second flange parts on each other and welding the second flange parts to each other in such a manner as to close the other edge part.

In this configuration, during manufacture of the thermal insulation panel, it is sufficient to perform welding only at the flange parts along the two sides corresponding to the one edge part and the other edge part of the flattened metal cylinder and welding is not required to be performed along the other two sides facing each other. This makes it possible to shorten a welding length significantly compared to the case where welding is performed along an entire periphery covering the four sides of a panel. This considerably reduces welding operation during manufacture of the thermal insulation panel to achieve improvement of manufacturing efficiency. Moreover, as a welding length can be shortened significantly during manufacture of the thermal insulation panel, welding cost is reduced considerably to achieve reduction in manufacturing cost. Furthermore, in fitting the thermal insulation support into the flattened metal cylinder, the flattened metal cylinder having a pouched shape opened along one side can be used as an intermediate member. The thermal insulation support can easily be fitted into the flattened metal cylinder in such a manner as to be housed into the flattened metal cylinder of a pouched shape from the opened side, in other words, in such a manner as to be packed into the flattened metal cylinder. At the same time, the thermal insulation support can correctly be fitted into an intended internal region of the flattened metal cylinder and can be fitted internally at intended density that may be high density, for example.

A method for manufacturing a thermal insulation panel of the present invention comprises: a first step of forming a flattened metal cylinder by deforming a metal cylinder under pressure in such a manner as to squeeze the metal cylinder; a second step of fitting a thermal insulation support into the flattened metal cylinder; a third step of forming first flange parts at an edge part on one side of an axis direction of the flattened metal cylinder, and overlaying the first flange parts on each other and welding the first flange parts to each other in such a manner as to close the one edge part; and a fourth step of forming second flange parts at an edge part on the other side of the axis direction of the flattened metal cylinder, and overlaying the second flange parts on each other and welding the second flange parts to each other in such a manner as to close the other edge part.

In this configuration, during manufacture of the thermal insulation panel, it is sufficient to perform welding only at the flange parts along the two sides corresponding to the one edge part and the other edge part of the flattened metal cylinder and welding is not required to be performed along the other two sides facing each other. This makes it possible to shorten a welding length significantly compared to the case where welding is performed along an entire periphery covering the four sides of a panel. This considerably reduces welding operation during manufacture of the thermal insulation panel to achieve improvement of manufacturing efficiency. Moreover, as a welding length can be shortened significantly during manufacture of the thermal insulation panel, welding cost is reduced considerably to achieve reduction in manufacturing cost. Furthermore, the thermal insulation support is fitted into the flattened metal cylinder before the both edge parts of the flattened metal cylinder in the axis direction are closed. By doing so, if a thermal insulation support to be used has directional property in order to make the best possible use of its thermal insulation property that may be a thermal insulation support containing fiber such as glass wool oriented vertical to a direction of thermal conduction or a thermal insulation support having a stack of layer materials containing fiber such as glass wool oriented vertical to a direction of thermal conduction, for example, it is possible to fit and install the thermal insulation support into the flattened metal cylinder easily and reliably while the directional property is maintained by adjusting the direction of the thermal insulation support at the edge parts both in an opened state on the opposite sides, for example.

The method for manufacturing the thermal insulation panel of the present invention is characterized in that, in the fourth step, the second flange parts are welded to each other while a part of a region in a side direction where the second flange parts are overlaid on each other is left as an exhaust port, the interior of the flattened metal cylinder is evacuated through the left exhaust port, and then the exhaust port is sealed.

In this configuration, leakage from the welded part formed during manufacture of the thermal insulation panel becomes a serious factor for time degradation of a vacuum thermal insulation panel. In this regard, the welded parts are formed limitedly along the two sides compared to the entire periphery of the panel to reduce the welded part during manufacture of the thermal insulation panel. By doing so, it becomes possible to considerably reduce a likelihood of the occurrence of leakage due to time degradation. Furthermore, fitting the thermal insulation support into the reduced-pressure space makes it possible to retain the reduced-pressure space stably for a long time and maintain high thermal insulation performance. Moreover, by conducting evacuation through the exhaust port where the second flange parts are left unwelded and sealing the exhaust port, it becomes unnecessary to perform a step of forming an additional exhaust port at a peripheral wall of the flattened metal cylinder. This achieves still higher efficiency in manufacturing operation.

### Advantageous Effects of Invention

According to the present invention, it is possible to improve manufacturing efficiency and reduce manufacturing cost by shortening a welding length significantly and reducing welding operation during manufacture of a thermal insulation panel.

### BRIEF DESCRIPTION OF DRAWINGS

FIG. 1 is a perspective view showing a thermal insulation panel according to an embodiment of the present invention.

FIG. 2 is a plan view showing the thermal insulation panel according to the embodiment.

FIG. 3(a) is an enlarged sectional view taken along A-A in FIG. 2 and FIG. 3(b) is an enlarged sectional view taken along B-B in FIG. 2.

FIG. 4 is an enlarged view of an area C in FIG. 3.

FIG. 5 is an enlarged view of an area D in FIG. 3.

FIG. 6 is an enlarged view of an area E in FIG. 3.

FIGS. 7(a) to 7(c) are process explanatory views for explaining the first half of a process of manufacturing the thermal insulation panel according to the embodiment.

FIGS. 8(a) and 8(b) are process explanatory views for explaining the latter half of the process of manufacturing the thermal insulation panel according to the embodiment.

FIG. 9 is a partial enlarged sectional view according to a modification of the thermal insulation panel of the embodiment showing a section corresponding to FIG. 4.

### EMBODIMENTS FOR CARRYING OUT INVENTION

[Thermal Insulation Panel and Method for Manufacturing the Same According to Embodiment]

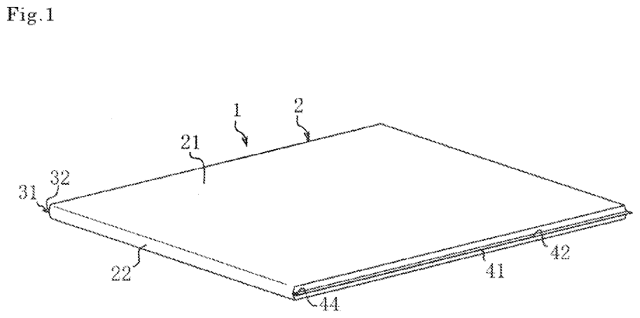

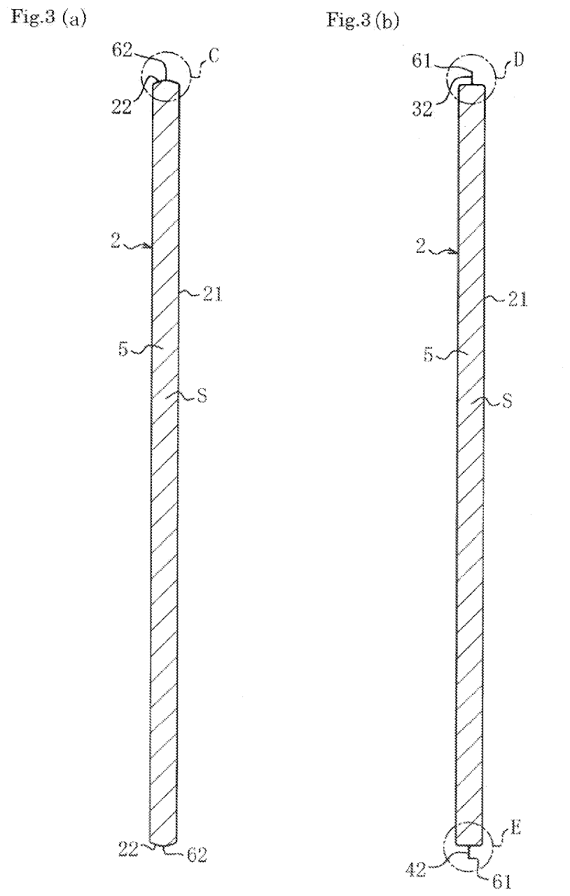

As shown in FIGS. 1 to 6, a thermal insulation panel 1 according to an embodiment of the present invention is made of a metal material such as aluminum or stainless steel, and is composed of a flattened metal cylinder 2 formed by flattening a metal cylinder 2m under pressure. At an edge part 31 on one side of an axis direction of the flattened metal cylinder 2, first flange parts 32 are formed in such a manner as to squeeze the one edge part 31. While the first flange parts 32, 32 are overlaid on each other in such a manner as to close the one edge part 31, the first flange parts 32, 32 are welded to each other at a welded part 33. The welded part 33 is formed to extend in a direction in which the overlaid first flange parts 32, 32 extend and formed along an entire length of a side 61 described later.

At an edge part 41 on the other side of the axis direction of the flattened metal cylinder 2, second flange parts 42 are formed in such a manner as to squeeze the other edge part 41. While the second flange parts 42, 42 are overlaid on each other in such a manner as to close the other edge part 41, the second flange parts 42, 42 are welded to each other at a welded part 43. The welded part 43 is formed to extend in a direction in which the overlaid second flange parts 42, 42 extend and formed along an entire length of a side 61 except a sealing part 44 sealing an exhaust port for evacuation formed at the side 61 described later. The welded parts 33 and 43 may be formed by an applicable and appropriate welding method such as seam welding or laser welding, for example.

The thickness of the flattened metal cylinder 2 is determined appropriately within a range allowing formation of the thermal insulation panel of the present invention. This thickness is preferably from 0.05 to 1.0 mm, for example. If the flattened metal cylinder 2 is to be formed into a considerably small thickness that may be equal to or less than 0.1 mm in an intermediate region of the axis direction between a peripheral region of the one edge part 31 and a peripheral region of the other edge part 41 of the flattened metal cylinder 2, for example, formation of the welded parts 33 and 43 is facilitated preferably by forming each of the peripheral region of the one edge part 31 where the first flange parts 32 are to be formed and the peripheral region of the other edge part 41 where the second flange parts 42 are to be formed into a thickness such as from 0.3 to 0.5 mm greater than the thickness in the intermediate region, for example.

Thermal insulation space S is provided inside the flattened metal cylinder 2 closed at the welded parts 33 and 43. In the present embodiment, the thermal insulation space S of the thermal insulation panel 1 is reduced-pressure space. Fitting a thermal insulation support 5 into the reduced-pressure space makes the thermal insulation panel 1 functional as a vacuum thermal insulation panel. An appropriate material to exert resistance to atmospheric pressure outside the thermal insulation panel 1 and to exert thermal insulation performance is applicable to the thermal insulation support 5 to be fitted internally. For example, the thermal insulation support 5 may be formed by filling a fiber material such as rock wool or glass wool to intended density or may be foamed plastic, for example. While the thermal insulation panel 1 of the present embodiment is described as a vacuum thermal insulation panel in which the thermal insulation space S is reduced-pressure space, the thermal insulation panel of the present invention is also favorably a thermal insulation panel in which the thermal insulation space S is not reduced-pressure space but is composed of an air layer.

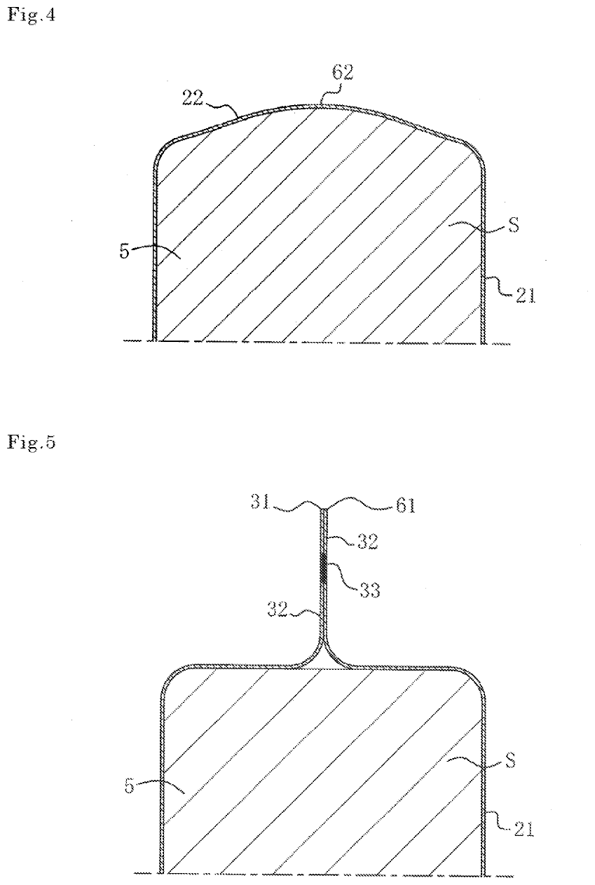

In comparison to the two sides 61, 61 of the thermal insulation panel 1 facing each other where the one edge part 31 is welded at the welded part 33 and the other edge part 41 is welded at the welded part 43, two sides 62, 62 facing each other and differing from the two sides 61, 61 facing each other are formed by bending a peripheral wall 21 of the flattened metal cylinder 2. In the thermal insulation panel 1 of the present embodiment, a curved part 22 having a gentle chevron shape in a sectional view is formed along each of the two sides 62, 62 facing each other by bending the peripheral wall 21 of the flattened metal cylinder 2 (see FIG. 4).

The thermal insulation space S is provided adjacent to the two sides 62, 62 facing each other. In the present embodiment, the thermal insulation space S as reduced-pressure space is provided adjacent to the two sides 62, 62 facing each other. The thermal insulation support 5 is also fitted into an area of the thermal insulation space S as reduced-pressure space adjacent to the two sides 62, 62 facing each other. Specifically, a region in which thermal insulation performance is achievable extends as far as to positions adjacent to the two sides 62, 62 facing each other formed by bending the peripheral wall 21 of the flattened metal cylinder 2.

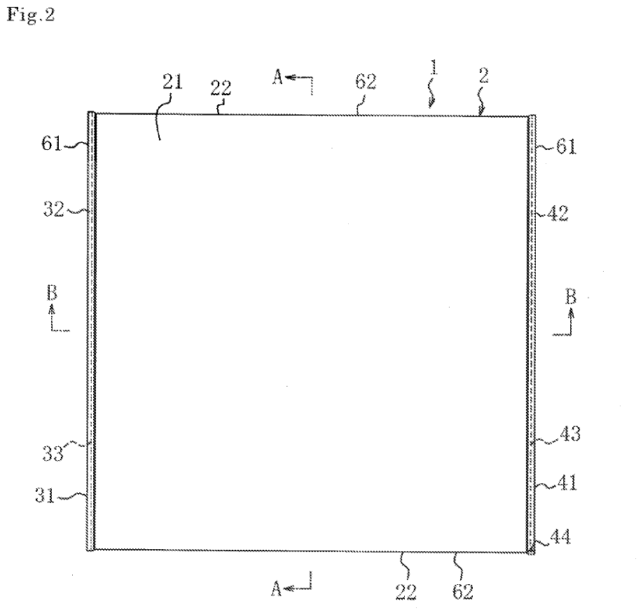

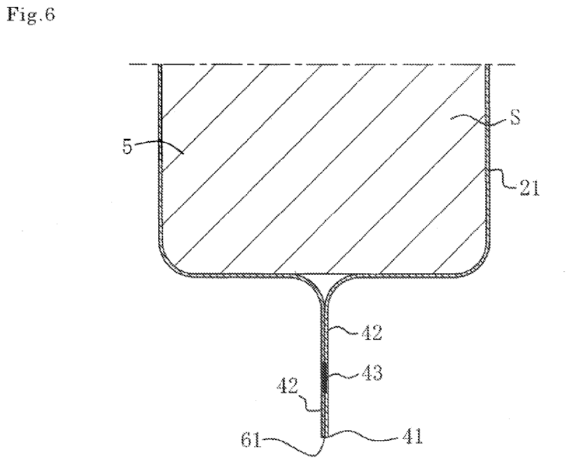

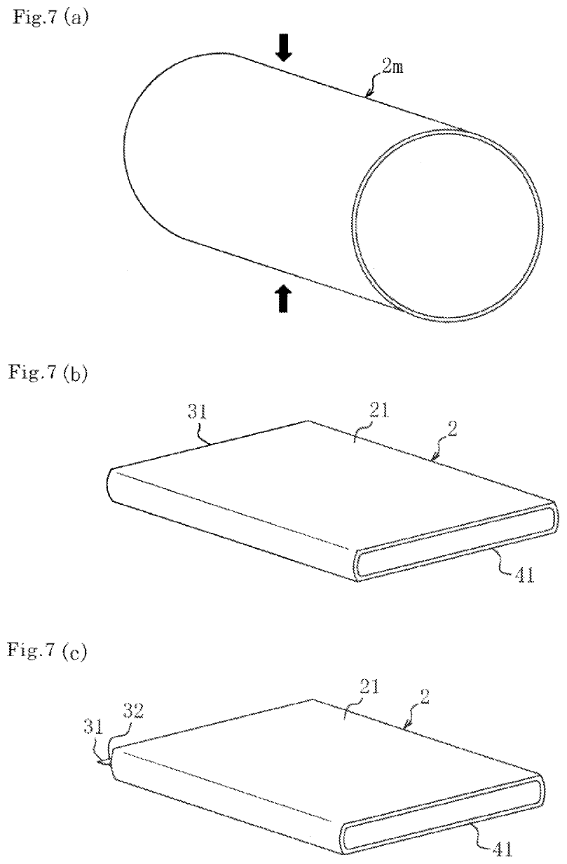

A manufacturing process of manufacturing the thermal insulation panel 1 of the present embodiment will be described next. In manufacturing the thermal insulation panel 1, by using the metal cylinder 2m made of a metal material such as aluminum or stainless steel, the metal cylinder 2m is deformed under pressure and flattened under pressure in such a manner as to be squeezed as shown by bold lines with arrows in FIG. 7(a) to form the flattened metal cylinder 2 (see FIGS. 7(a) and 7(b)). Then, the edge part 31 on one side of the axis direction of the flattened metal cylinder 2 is deformed under pressure in such a manner as to be squeezed to form the first flange parts 32. The first flange parts 32, 32 are overlaid on and welded to each other in such a manner as to close the one edge part 31, so that the welded part 33 is formed in such a manner as to extend in a direction in which the overlaid first flange parts 32, 32 extend (see FIGS. 7(c), 2, and 5).

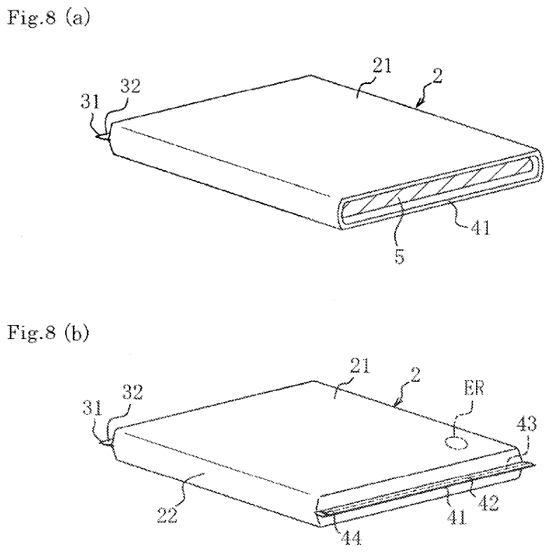

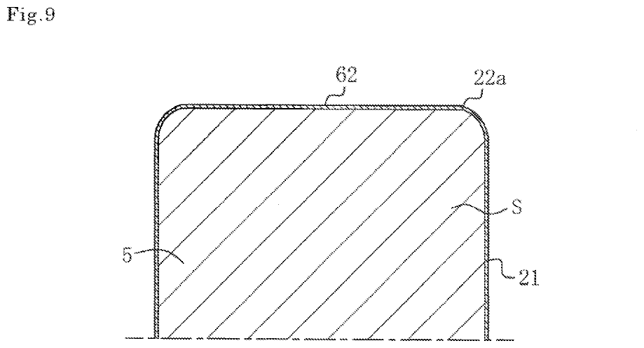

After the one edge part 31 of the flattened metal cylinder 2 is closed, a fiber material that may be rock wool or glass wool, for example, is filled to intended density through the other edge part 41 in an opened state to fit the thermal insulation support 5 into the flattened metal cylinder 2 (see FIG. 8(a)). Then, the edge part 41 on the other side of the axis direction of the flattened metal cylinder 2 is deformed under pressure in such a manner as to be squeezed to form the second flange parts 42. The second flange parts 42, 42 are overlaid on and welded to each other in such a manner as to close the other edge part 42, so that the welded part 43 is formed in such a manner as to extend in a direction in which the overlaid second flange parts 42, 42 extend (see FIGS. 8(b), 2, and 6).

To manufacture a thermal insulation panel including an air layer as the thermal insulation space S, the welded part 43 is formed along the entire length of the side 61 in the step of overlaying and welding the second flange parts 42, 42 in such a manner as to close the other edge part 42. Meanwhile, in the case of the thermal insulation panel 1 of the present embodiment including reduced-pressure space as the thermal insulation space S, the second flange parts 42, 42 are welded to each other at the welded part 43 while a part of a region in a side direction where the second flange parts 42, 42 are overlaid on each other is left as an exhaust port. Then, the interior of the flattened metal cylinder 2 is evacuated through the left exhaust port and the exhaust port is thereafter sealed with the sealing part 44 formed by brazing or glass sealing, for example.

To manufacturing the thermal insulation panel of the present invention including reduced-pressure space as the thermal insulation space S, the step of performing welding at the welded part 43 except the above-described exhaust port and sealing the exhaust port with the sealing part 44 may favorably be replaced with a step performed appropriately during the entire manufacturing process in which an exhaust port is formed in an exhaust region ER in the metal cylinder 2m or in the peripheral wall 21 of the flattened metal cylinder 2, the interior of the flattened metal cylinder 2 is evacuated through this exhaust port, and then the exhaust port is sealed with a sealing part formed by brazing or glass sealing, for example.

According to the present embodiment, during manufacture of the thermal insulation panel 1, it is sufficient to perform welding only at the flange parts 31 and the flange parts 41 along the two sides 61, 61 corresponding to the one edge part 31 and the other edge part 41 of the flattened metal cylinder 2 and welding is not required to be performed along the other two sides 62, 62 facing each other. This makes it possible to shorten a welding length significantly compared to the case where welding is performed along an entire periphery covering the four sides of a panel. This considerably reduces welding operation during manufacture of the thermal insulation panel 1 to achieve improvement of manufacturing efficiency. Moreover, as a welding length can be shortened significantly during manufacture of the thermal insulation panel 1, welding cost is reduced considerably to achieve reduction in manufacturing cost.

If the thermal insulation panel 1 is a vacuum thermal insulation panel including reduced-pressure space inside the panel, leakage from the welded part formed during manufacture of the thermal insulation panel becomes a serious factor for time degradation of the vacuum thermal insulation panel. In this regard, the welded parts 33 and 43 are formed limitedly along the two sides compared to the entire periphery of the panel to reduce the welded part during manufacture of the thermal insulation panel 1. By doing so, it becomes possible to considerably reduce a likelihood of the occurrence of leakage due to time degradation. Furthermore, fitting the thermal insulation support 5 into the reduced-pressure space makes it possible to retain the reduced-pressure space stably for a long time and maintain high thermal insulation performance.

By providing the reduced-pressure space adjacent to the two sides 62, 62 facing each other and differing from the welded two sides 61, 61 facing each other, it becomes possible to extend a panel region to contribute to thermal insulation property more widely while minimizing a panel region corresponding to a wide flange part for welding and not to contribute to thermal insulation property in an extension direction of a panel surface. As a result, the thermal insulation property of the vacuum thermal insulation panel can be improved further. Furthermore, the dimension of the reduced-pressure space adjacent to the two sides 62, 62 facing each other is retained by the thermal insulation support 5 to allow the state of the reduced-pressure space to be maintained stably for a long time in the above-described adjacent area, making it possible to maintain high thermal insulation performance. In the case where the thermal insulation space S is not reduced-pressure space but is an air layer, by providing the thermal insulation space S adjacent to the two sides 62, 62 facing each other and differing from the welded two sides 61, 61 facing each other, it also becomes possible to extend a panel region to contribute to thermal insulation property more widely while minimizing a panel region corresponding to a wide flange part for welding and not to contribute to thermal insulation property in an extension direction of a panel surface. As a result, the thermal insulation property of the thermal insulation panel can also be improved further.

By deforming the metal cylinder 2m under pressure and flattening the metal cylinder 2m under pressure in such a manner as to squeeze the metal cylinder 2m to form the flattened metal cylinder 2, elastic restoring force is generated during the deformation under pressure in squeezing or generated in a deformed state as a result of the flattening under pressure to allow a thickness in the thermal insulation space inside the panel to be maintained stably for a long time. This contributes to extension of product lifetime.

In fitting the thermal insulation support 5 into the flattened metal cylinder 2 during manufacture of the thermal insulation panel 1, by performing the manufacturing step using the flattened metal cylinder 2 as an intermediate member having a pouched shape opened along one side, the thermal insulation support 5 can easily be fitted into the flattened metal cylinder 2 in such a manner as to be housed into the flattened metal cylinder 2 of a pouched shape from the opened side, in other words, in such a manner as to be packed into the flattened metal cylinder 2. At the same time, the thermal insulation support 5 can correctly be fitted into an intended internal region of the flattened metal cylinder 2 and can be fitted internally at intended density that may be high density, for example.

If the manufacturing step of conducting evacuation through the exhaust port where the second flange parts 42 are left unwelded and sealing the exhaust port with the sealing part 44 is used, it becomes unnecessary to perform a step of forming an additional exhaust port at the peripheral wall 21 of the flattened metal cylinder 2. This achieves still higher efficiency in manufacturing operation.

[Scope of Invention Disclosed in this Specification]

The invention disclosed in this specification includes, in addition to the configurations according to the respective inventions and embodiments listed as inventions, a matter defined by modifying any of these partial configurations into other configurations disclosed in this specification within an applicable range, a matter defined by adding any other configurations disclosed in this specification to these partial configurations, or a matter defined into a generic concept by cancelling any of these partial configurations within a limit that achieves a partial operational advantage. The invention disclosed in this specification further covers modifications and additions described below.

As an example, in the thermal insulation panel 1 of the embodiment described above, the curved part 22 of each of the two sides 62, 62 facing each other is formed into a gentle chevron shape in a sectional view. Meanwhile, as shown in a modification of FIG. 9, a curved part 22a having an approximately angular U-shape in a sectional view may be formed favorably by bending the peripheral wall 21 of the flattened metal cylinder 2. In a favorable configuration of the modification of forming the curved part 22a, the thermal insulation support 5 is also fitted into an area of the thermal insulation space S as reduced-pressure space adjacent to the two sides 62, 62 facing each other.

If necessary, for the purpose of forming the thermal insulation panel into a shape more approximate to a quadrangular shape, for example, flange parts having respective shapes corresponding to those in FIGS. 5 and 6 may also be formed at the two sides 62, 62 facing each other and differing from the welded two sides 61, 61 facing each other. In this case, respective projections of the tips of the flange parts at the two sides 62, 62 are preferably smaller than projections of the tips of the first flange parts 32 and projections of the tips of the second flange parts 42 as it allows reduction in panel region not to contribute to thermal insulation property.

The shape of the thermal insulation panel of the present invention in a plan view is determined appropriately within an applicable range. In addition to the thermal insulation panel 1 of the above-described configuration illustrated in the drawings having a quadrangular shape in a plan view approximate to a generally square shape, a favorable configuration of a thermal insulation panel is such that the thermal insulation panel is composed of the flattened metal cylinder 2 having a greater length in an axis direction, and has an approximately rectangular shape in a plan view with each side 62 of the two sides 62, 62 of a length greater than the length of each side 61 of the two sides 61, 61. Compared to the configuration of a thermal insulation panel having four welded sides, this thermal insulation panel having an approximately rectangular shape in a plan view achieves the effect of shortening a welding length further and reducing welding operation.

Instead of the exemplary process of manufacturing the thermal insulation panel 1 of the embodiment described above, the thermal insulation panel 1 may also be formed favorably by a manufacturing process of a modification in which, after the metal cylinder 2m is deformed under pressure and flattened under pressure in such a manner as to be squeezed to form the flattened metal cylinder 2 and then the thermal insulation support 5 is fitted into the flattened metal cylinder 2, the edge part 31 on one side of the axis direction of the flattened metal cylinder 2 is deformed under pressure in such a manner as to be squeezed to form the first flange parts 32 and the first flange parts 32, 32 are overlaid on and welded to each other in such a manner as to close the one edge part 31, thereby forming the welded part 33 in such a manner as to extend the welded part 33 in a direction in which the overlaid first flange parts 32, 32 extend. Furthermore, the edge part 41 on the other side of the axis direction of the flattened metal cylinder 2 is deformed under pressure in such a manner as to be squeezed to form the second flange parts 42 and the second flange parts 42, 42 are overlaid on and welded to each other in such a manner as to close the other edge part 42, thereby forming the welded part 43 in such a manner as to extend the welded part 43 in a direction in which the overlaid second flange parts 42, 42 extend. According to this manufacturing process of the modification, if a thermal insulation support to be used has directional property in order to make the best possible use of its thermal insulation property that may be a thermal insulation support containing fiber such as glass wool oriented vertical to a direction of thermal conduction or a thermal insulation support having a stack of layer materials containing fiber such as glass wool oriented vertical to a direction of thermal conduction, for example, it is possible to fit and install the thermal insulation support into the flattened metal cylinder easily and reliably while the directional property is maintained by adjusting the direction of the thermal insulation support at the edge parts both in an opened state on the opposite sides, for example.

### INDUSTRIAL APPLICABILITY

The present invention is available as a thermal insulation panel for cooling boxes, warming boxes, and construction materials, as a thermal insulation panel forming containers for retaining heat of batteries of automobiles, etc., and as a thermal insulation panel for thermal insulation between cells of a battery of an automobile, for example.

### REFERENCE SIGNS LIST

1 . . . Thermal insulation panel
2 . . . Flattened metal cylinder
21 . . . Peripheral wall
22, 22a . . . Curved part
2m . . . Metal cylinder
31 . . . One edge part
32 . . . First flange part
33 . . . Welded part
41 . . . Other edge part
42 . . . Second flange part
43 . . . Welded part
44 . . . Sealing part
5 . . . Thermal insulation support
61, 62 . . . Side
S . . . Thermal insulation space
ER . . . Exhaust region

1-9. (canceled)

10. A thermal insulation panel wherein
first flange parts are formed at an edge part on one side of an axis direction of a flattened metal cylinder and the first flange parts are overlaid on and welded to each other in such a manner as to close the one edge part,
second flange parts are formed at an edge part on the other side of the axis direction of the flattened metal cylinder and the second flange parts are overlaid on and welded to each other in such a manner as to close the other edge part, and
thermal insulation space is provided inside the flattened metal cylinder.

11. The thermal insulation panel according to claim 10, wherein
the thermal insulation space is reduced-pressure space and a thermal insulation support is fitted into the reduced-pressure space.

12. The thermal insulation panel according to claim 11, wherein
the reduced-pressure space is provided adjacent to two sides facing each other and differing from two sides facing each other where the one edge part is welded and the other edge part is welded respectively, and
the thermal insulation support is fitted into an area of the reduced-pressure space adjacent to the two sides.

13. The thermal insulation panel according to claim 10, wherein
the thermal insulation space is provided adjacent to two sides facing each other and differing from two sides facing each other where the one edge part is welded and the other edge part is welded respectively.

14. The thermal insulation panel according to claim 10, wherein
the flattened metal cylinder is formed by flattening under pressure.

15. The thermal insulation panel according to claim 11, wherein
the flattened metal cylinder is formed by flattening under pressure.

16. The thermal insulation panel according to claim 12, wherein
the flattened metal cylinder is formed by flattening under pressure.

17. The thermal insulation panel according to claim 13, wherein
the flattened metal cylinder is formed by flattening under pressure.

18. A method for manufacturing the thermal insulation panel according to claim 14, comprising:
a step of forming a flattened metal cylinder by deforming a metal cylinder under pressure in such a manner as to squeeze the metal cylinder.

19. A method for manufacturing the thermal insulation panel according to claim 15, comprising:
a step of forming a flattened metal cylinder by deforming a metal cylinder under pressure in such a manner as to squeeze the metal cylinder.

20. A method for manufacturing the thermal insulation panel according to claim 16, comprising:
a step of forming a flattened metal cylinder by deforming a metal cylinder under pressure in such a manner as to squeeze the metal cylinder.

21. A method for manufacturing the thermal insulation panel according to claim 17, comprising:
a step of forming a flattened metal cylinder by deforming a metal cylinder under pressure in such a manner as to squeeze the metal cylinder.

22. A method for manufacturing a thermal insulation panel comprising:
a first step of forming a flattened metal cylinder by deforming a metal cylinder under pressure in such a manner as to squeeze the metal cylinder;
a second step of forming first flange parts at an edge part on one side of an axis direction of the flattened metal cylinder, and overlaying the first flange parts on each other and welding the first flange parts to each other in such a manner as to close the one edge part;
a third step of fitting a thermal insulation support into the flattened metal cylinder; and
a fourth step of forming second flange parts at an edge part on the other side of the axis direction of the flattened metal cylinder, and overlaying the second flange parts on each other and welding the second flange parts to each other in such a manner as to close the other edge part.

23. A method for manufacturing a thermal insulation panel comprising:
a first step of forming a flattened metal cylinder by deforming a metal cylinder under pressure in such a manner as to squeeze the metal cylinder;
a second step of fitting a thermal insulation support into the flattened metal cylinder;
a third step of forming first flange parts at an edge part on one side of an axis direction of the flattened metal cylinder, and overlaying the first flange parts on each other and welding the first flange parts to each other in such a manner as to close the one edge part; and
a fourth step of forming second flange parts at an edge part on the other side of the axis direction of the flattened metal cylinder, and overlaying the second flange parts on each other and welding the second flange parts to each other in such a manner as to close the other edge part.

24. The method for manufacturing the thermal insulation panel according to claim 22, wherein
in the fourth step, the second flange parts are welded to each other while a part of a region in a side direction where the second flange parts are overlaid on each other is left as an exhaust port, the interior of the flattened metal cylinder is evacuated through the left exhaust port, and then the exhaust port is sealed.

25. The method for manufacturing the thermal insulation panel according to claim 23, wherein
in the fourth step, the second flange parts are welded to each other while a part of a region in a side direction where the second flange parts are overlaid on each other is left as an exhaust port, the interior of the flattened metal cylinder is evacuated through the left exhaust port, and then the exhaust port is sealed.
